(19) United States
(12) Patent Application Publication
(10) Pub. No.: US 2026/0151807 A1
(43) Pub. Date: Jun. 4, 2026

(54) SOLID WASTE REMEDIATION PROCESS

(71) Applicant: JGB INNOVATIONS PTY LTD, Pyrmont (AU)

(72) Inventors: Pedro Balbachevsky, Pyrmont (AU); Vagner Jorden, Pyrmont (AU)

(21) Appl. No.: 19/123,522

(22) PCT Filed: Apr. 30, 2024
(86) PCT No.: PCT/AU2024/050414

§ 371 Date: Apr. 23, 2025

(30) Foreign Application Priority Data
May 5, 2023 (AU) 2023901355

(51) Int. Cl. B09C 1/02; B09B 3/80; B09B 101/90

(52) U.S. Cl. CPC B09C 1/02; B09B 3/80; B09B 2101/90

(57) ABSTRACT

A method of reducing a concentration of PFAS in a solid waste is disclosed. The method comprises combining the solid waste with an alcohol solution to provide a mixture of a solid phase and a liquid phase in which the solid phase comprises insoluble components of the solid waste and the liquid phase comprises the alcohol solution and at least a portion of the PFAS. The solid phase and the liquid phase are then separated to provide cleaned solid waste and an alcohol solution comprising PFAS.

### FIELD OF THE DISCLOSURE

The present disclosure broadly relates to a method and apparatus for remediating a solid waste impacted by perfluoroalkyl and polyfluoroalkyl substances (PFAS).

### BACKGROUND OF THE DISCLOSURE

Any discussion of the prior art throughout this specification should in no way be considered as an admission that such prior art is widely known or forms part of the common general knowledge in the field.

Perfluoroalkyl and polyfluoroalkyl substances (PFAS) are generally defined as chemical compounds having an alkyl chain substituted with multiple fluorine atoms. Many PFAS are also surfactants. These compounds have extensive household and industrial applications. Once PFAS make their way into the environment, they are a highly persistent pollutant. PFAS can also accumulate in the human body, and there is concern that exposure to PFAS leads to adverse health outcomes.

PFAS contamination of solid waste, such as soil, occurs in many sites world-wide. Such sites often require remediation, that is, treatment of the solid waste to remove or contain the PFAS. In the case of soil, conventional methods of treating PFAS-contamination include, most commonly, in situ soil flushing with water, in situ immobilisation (leachability control) or excavation and removal of impacted soil followed by decontamination using thermal treatments.

A need exists for alternative and/or improved methods of remediation of PFAS-contaminated solid waste.

### SUMMARY OF THE DISCLOSURE

In a first aspect of the disclosure, there is provided a method of reducing a concentration of a perfluoroalkyl and polyfluoroalkyl substance (PFAS) in a solid waste containing a PFAS, the method comprising:
(i) combining the solid waste with an alcohol solution to provide a mixture of a solid phase and a liquid phase; wherein the solid phase comprises insoluble components of the solid waste, and the liquid phase comprises the alcohol solution and at least a portion of the PFAS;
(ii) separating the solid phase and the liquid phase to provide cleaned solid waste and an alcohol solution comprising PFAS.

The following options may be used in conjunction with the first aspect of the disclosure, either individually or in any suitable combination.

The method may further comprise: (iii) repeating steps (i) and (ii) at least once, wherein the solid waste in step (i) is the cleaned solid waste obtained in step (ii).

The method may further comprise: (iv) distilling the alcohol solution comprising PFAS to provide alcohol substantially free from PFAS and a brine containing at least a portion of the PFAS. In step (i) the alcohol solution may comprise the alcohol substantially free from PFAS obtained in step (iv).

The method may further comprise a step (i.a.) prior to step (i), wherein step (i.a.) comprises measuring the electrical conductivity and/or moisture of the solid waste containing a PFAS and adjusting the electrical conductivity and/or moisture of the solid waste if it does not fall within a target range.

The method may be an ex situ method. The method may be performed on site.

The method may be performed at ambient temperature. The method may be performed at ambient pressure. Any one or more of the steps of the method may be performed at ambient temperature and/or at ambient pressure. It will be understood that step (iv) of distilling the alcohol solution is commonly performed above ambient temperature and/or below ambient pressure. Thus the method, other than step (iv) if conducted, may be performed at ambient temperature and/or at ambient pressure.

The solid waste may be a soil. The soil may contain clay. The soil may contain at least 15% w/w clay.

The alcohol solution may comprise an alcohol and water. The alcohol solution may comprise at least about 40% v/v alcohol. The alcohol may be selected from the group consisting of ethanol, methanol, 1-propanol, 2-propanol, 1-butanol, 2-butanol, and tert-butanol. The alcohol may be ethanol.

The PFAS may be, or may comprise, one or more compounds selected from the group consisting of perfluorobutanoic acid (PFBA), perfluoropentanoic acid (PFPeA), perfluorohexanoic acid (PFHxA), perfluoroheptanoic acid (PFHpA), perfluorooctanoic acid (PFOA), perfluorononanoic acid (PFNA), perfluorodecanoic acid (PFDA), perfluoroundecanoic acid (PFUnA), perfluorododecanoic acid (PFDoA), perfluorotridecanoic acid (PFTrDA), perfluorotetradecanoic acid (PFTeDA), perfluorohexadecanoic acid (PFHxDA), perfluorobutane sulfonate (PFBS), perfluoropentane sulfonate (PFPeS), perfluorohexane sulfonate (PFHxS), perfluoroheptane sulfonate (PFHpS), perfluorooctane sulfonate (PFOS), perfluorononane sulfonate (PFNS), perfluorodecane sulfonate (PFDS), perfluorododecane sulfonate (PFDoS), 1H,1H,2H,2H-perfluorohexane sulfonate (4:2) (4:2 FTS), 1H, 1H,2H,2H-perfluorooctane sulfonate (6:2) (6:2 FTS), 1H,1H,2H,2H-perfluorodecane sulfonate (8:2) (8:2 FTS), perfluoroctane sulfonamide (PFOSA), N-methylperfluoroctane sulfonamide (N-MeFOSA), N-ethylperfluoroctane sulfonamide (N-EtFOSA), 2-(N-methylperfluorooctane sulfonamido)-ethanol, 2-(N-ethylperfluorooctane sulfonamido)-ethanol, N-methylperfluorooctanesulfonamidoacetic acid, and N-ethylperfluorooctanesulfonamidoacetic acid. The PFAS may be, or may comprise, one or more compounds selected from the group consisting of perfluorooctanoic acid (PFOA), perfluorooctane sulfonate (PFOS), and perfluorohexanoic acid (PFHxA). The PFAS may be a mixture of compounds, each of which is an organic compound having an alkyl chain bearing multiple fluorine atoms.

The mass ratio of the solid waste containing a PFAS to the alcohol solution may be between about 1:1 and about 3:1. The mass ratio of solid waste containing a PFAS to the alcohol solution may be between about 2:1 and about 2.5:1.

In step (ii), separating the solid phase and the liquid phase may be performed using a dewatering screw press. Step (i) may be performed in the tank of the dewatering screw press. Step (ii) may be performed by the screw auger of the dewatering screw press.

The concentration of a PFAS in the solid waste containing a PFAS may be reduced by at least about 15%.

In a second aspect of the disclosure, there is provided an apparatus for reducing the concentration of a perfluoroalkyl and polyfluoroalkyl substance (PFAS) in a solid waste containing a PFAS, the apparatus comprising:
(i) a separation unit for separating a mixture of the solid waste and an alcohol solution, the separation unit having a solvent inlet for receiving the alcohol solution or components thereof, a liquid phase outlet for expelling a separated liquid phase, and a solid phase outlet for expelling a separated solid phase; and
(ii) a solvent recovery unit for recovering alcohol substantially free from PFAS from the separated liquid phase, the solvent recovery unit having a liquid inlet for receiving the separated liquid phase, a recovered solvent outlet for expelling recovered solvent and a brine outlet for expelling brine;
wherein the liquid inlet of the solvent recovery unit is in fluid communication with the liquid phase outlet of the separation unit, and the recovered solvent outlet of the solvent recovery unit is in fluid communication with the solvent inlet of the separation unit.

The following options may be used in conjunction with the second aspect of the disclosure, either individually or in any suitable combination.

The separation unit may comprise a mixing unit for mixing the solid waste and the alcohol solution. The mixing unit may comprise a vessel in which the solid waste and the alcohol solution are combined. It may comprise a solid inlet for admitting the solid waste. The solid inlet and the liquid inlet may be the same or may be separate. The mixing unit may comprise an agitation device for agitating the contents of the vessel. The agitation device may be disposed at least partially within, or may be coupled to, the vessel. It may be disposed so as to agitate the contents of the vessel or it may be disposed so as to agitate the vessel itself, thereby agitating the contents thereof. The vessel may comprise one or more closure devices to prevent egress of solid waste or alcohol solution (or solid phase or liquid phase) from the vessel during agitation. The apparatus may further comprise a brine storage tank in fluid communication with the brine outlet of the solvent recovery unit.

The apparatus may further comprise a solvent storage tank, in fluid communication with the recovered solvent outlet of the solvent recovery unit and the solvent inlet of the separation unit. The solvent storage tank may be in fluid communication with the solvent inlet of the separation unit for enabling recovered solvent to be used the separation unit.

The apparatus may further comprise an electronic controller for operating the apparatus.

The separation unit may comprise a dewatering screw press.

The solvent recovery unit may comprise a boiler and a condenser.

### Definitions

The following are some definitions that may be helpful in understanding the description of the present disclosure. These are intended as general definitions and should in no way limit the scope of the present disclosure to those terms alone, but are put forth for a better understanding of the following description.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The terms “a” and “an” are used herein to refer to one or to more than one (i.e. to at least one) of the grammatical object of the article. By way of example, “an element” means one element or more than one element.

The term “about” is understood to refer to +10% of the recited value.

Any numerical range recited herein is intended to include all sub-ranges of the same numerical precision subsumed within the recited range. For example, a range of 1.0 to 5.0 is intended to include all sub-ranges between (and including) the recited minimum value of 1.0 and the recited maximum value of 5.0, that is, having a minimum value equal to or greater than 1.0 and a maximum value equal to or less than 5.0, such as 2.1 to 4.5. Any maximum numerical limitation recited herein is intended to include all lower numerical limitations subsumed therein and any minimum numerical limitation recited herein is intended to include all higher numerical limitations subsumed therein.

The term “may” should be taken to encompass the opposite unless the context indicates otherwise. Thus, for example, the statement “A may be B” should be taken to contemplate both “A is B” and “A is not B”.

Any description of prior art documents herein, or statements herein derived from or based on those documents, is not an admission that the documents or derived statements are part of the common general knowledge of the relevant art.

For the purposes of description, all documents referred to herein are hereby incorporated by reference in their entirety unless otherwise stated

### BRIEF DESCRIPTION OF THE DRAWINGS

FIG. 1. Process flow diagram of an embodiment of the method of the first aspect of the invention involving recycling of the alcohol solution.

FIG. 2. An apparatus according to the second aspect of the invention.

FIG. 3. PFAS content of brine obtained in Example 1-Run 3.

FIG. 4. PFAS content of cleaned soil obtained in Example 1-Run 3.

FIG. 5. Percentage of PFAS remaining in cleaned soil obtained in Example 1-Run 3.

### DETAILED DESCRIPTION

The inventors have surprisingly found that washing of solid waste, such as soil, with an alcohol solvent provides improved removal of PFAS from PFAS-contaminated solid waste.

### Method of Removing PFAS

Accordingly, in a first aspect of the disclosure, there is provided a method of reducing the concentration of a perfluoroalkyl and polyfluoroalkyl substance (PFAS) in solid waste containing a PFAS, the method comprising:
(i) combining the solid waste with an alcohol solution to provide a mixture of a solid phase and a liquid phase; wherein the solid phase comprises insoluble components of the solid waste, and the liquid phase comprises the alcohol solution and at least a portion of the PFAS;
(ii) separating the solid phase and the liquid phase to provide cleaned solid waste and an alcohol solution comprising PFAS.

The method of the first aspect of the invention may result in reducing the concentration of a PFAS in the solid waste containing a PFAS by at least about 15%, or at least about 20, 30, 40, 50, 60, 70, 80, 90, 95, 99 or 99.5%. The concentration of the PFAS may be reduced by about 15%, or by about 20, 30, 40, 50, 60, 70, 80, 90, 95, 99 or 99.5%. By reducing the concentration by a certain percentage it is meant that the total mass of PFAS in the cleaned solid waste is the total mass of PFAS in the solid waste containing a PFAS, reduced by that percentage.

In the context of this specification, while the term PFAS is an acronym for perfluoroalkyl and polyfluoroalkyl substance, it is understood that a PFAS in the singular is a substance which is a perfluoroalkyl or a polyfluoroalkyl substance. It may be an organic chemical having at least one fully fluorinated carbon atom, or it may be a mixture of more than one such organic chemical. When referring to reducing the concentration of a PFAS, it is meant that the concentration of one or more individual PFAS compounds is reduced. The term PFAS includes compounds such as perfluorobutanoic acid (PFBA), perfluoropentanoic acid (PFPeA), perfluorohexanoic acid (PFHxA), perfluoroheptanoic acid (PFHpA), perfluorooctanoic acid (PFOA), perfluorononanoic acid (PFNA), perfluorodecanoic acid (PFDA), perfluoroundecanoic acid (PFUnA), perfluorododecanoic acid (PFDoA), perfluorotridecanoic acid (PFTrDA), perfluorotetradecanoic acid (PFTeDA), perfluorohexadecanoic acid (PFHxDA), perfluorobutane sulfonate (PFBS), perfluoropentane sulfonate (PFPeS), perfluorohexane sulfonate (PFHxS), perfluoroheptane sulfonate (PFHpS), perfluorooctane sulfonate (PFOS), perfluorononane sulfonate (PFNS), perfluorodecane sulfonate (PFDS), perfluorododecane sulfonate (PFDoS), 1H,1H,2H,2H-perfluorohexane sulfonate (4:2) (4:2 FTS), 1H, 1H,2H,2H-perfluorooctane sulfonate (6:2) (6:2 FTS), 1H, 1H,2H,2H-perfluorodecane sulfonate (8:2) (8:2 FTS), perfluoroctane sulfonamide (PFOSA), N-methylperfluoroctane sulfonamide (N-MeFOSA), N-ethylperfluoroctane sulfonamide (N-EtFOSA), 2-(N-methylperfluorooctane sulfonamido)-ethanol, 2-(N-ethylperfluorooctane sulfonamido)-ethanol, N-methylperfluorooctanesulfonamidoacetic acid, and N-ethylperfluorooctanesulfonamidoacetic acid. In some embodiments, the PFAS may include perfluorooctanoic acid (PFOA), perfluorooctane sulfonate (PFOS), and perfluorohexanoic acid (PFHxA). The inventors have surprisingly found that the method of the first aspect of the disclosure may be effective for the removal of a variety of chemically distinct PFAS from solid waste. For example, the method and apparatus of the invention may be effective in reducing the concentration of PFOS, PFOA and PFHxS in solid waste containing PFOS, PFOA and PFHxS.

The solid waste containing the PFAS may be solid waste that is removed from in situ, for example soil that is removed from its natural location in the ground. For example, the solid waste may be stored in a container or stockpiled. Thus the method of the first aspect of the disclosure may be an ex situ method. As the method may be an ex situ method, it may be performed either on site, i.e. at the location from which the solid waste was obtained, or off site, at a location other than that at which the solid waste was obtained. On site treatment is often seen as preferable to off site treatment.

The method may be performed batchwise. Thus a quantity of solid waste may be removed from its natural location and treated according to steps (i) and (ii) described earlier. The method may be an ex situ batchwise method. In some instances the method may be conducted in a pseudo-continuous mode in which more than one, for example 2, 3, 4 or 5 such quantities of solid waste are removed from their natural location and treated individually and concurrently according to steps (i) and (ii). An advantage of an ex situ batchwise method is that it facilitates agitation of the solid waste with the alcohol solution in order to improve the transfer of PFAS from the solid waste to the alcohol solution. In situ methods commonly require larger quantities of solvent and longer times in order to achieve the same amount of PFAS removal from solid waste. This entails increased expense and increased energy requirements if the solvent is to be recycled and risks contaminating surrounding areas with the solvent.

Solid waste is understood to encompass waste composed of any solid material, such as soil, rock, sand, waste from building and demolition, including bricks, concrete, glass, plastics, metal and timber, putrescible wastes, garden waste, biosolids, adsorbent media, and clinical waste as well as mixtures of any of these.

The solid waste may be soil. Soil typically contains sand, silt and clay in varying proportions (as well as water, gasses and organic matter). The sand, silt, and clay portion of soil is herein referred to as inorganic matter. The soil containing a PFAS may be a clay soil, that is, a soil having an increased proportion of clay relative to sand and silt. In some embodiments, the soil may contain at least 15% w/w clay, or at least about 30, 40, 50, 60, 70, 80, or at least about 90% w/w clay. The soil may contain at least 15% w/w clay. The soil may contain at least 50% w/w clay.

The solid waste containing a PFAS may contain at least about 0.01 mg/kg of a PFAS, or at least about 0.05, 0.1, 0.5, 1, 1.8, 2, 5, 10, 20, or at least about 50 mg/kg of a PFAS. The soil containing a PFAS may contain at least about 1.8 mg/kg of a PFAS. The solid waste containing a PFAS may contain between about 0.01 to 100 mg/kg of a PFAS, or between about 0.01 to 0.05, 0.01 to 0.1, 0.01 to 0.5, 0.01 to 1, 0.01 to 5, 0.01 to 10, 0.01 to 20, 0.05 to 0.1, 0.05 to 0.5, 0.05 to 1, 0.05 to 2, 0.05 to 5, 0.05 to 10, 0.05 to 20, 0.05 to 50, 0.1 to 0.5, 0.1 to 1, 0.1 to 2, 0.1 to 5, 0.1 to 10, 0.1 to 20, 0.1 to 50, 0.5 to 1, 0.5 to 2, 0.5 to 5, 0.5 to 10, 0.5 to 20, 0.5 to 50, 1 to 2, 1 to 5, 1 to 10, 1 to 20, 1 to 50, 2 to 5, 2 to 20, 2 to 20 2 to 50, 5 to 10, 5 to 20, 5 to 50, 10 to 20, 10 to 50, or between about 2 to 50 mg/kg. The solid waste containing a PFAS may contain between about 1.8 to 100 mg/kg of a PFAS. Where the solid waste is soil, PFAS are typically found to be strongly adsorbed onto the surface of clay particles, thus soils which are high in clay are expected to be more difficult to remediate. PFAS may also be adsorbed onto silt, sand, or organic matter, or may be present as a solid, liquid or in solution in water forming part of the soil.

In step (i) of the method of the first aspect of the disclosure, the solid waste is combined with an alcohol solution to provide a mixture of a solid phase and a liquid phase; wherein the solid phase comprises insoluble components of the solid waste, and the liquid phase comprises the alcohol solution and at least a portion of the PFAS. In this step, at least a portion of the PFAS found in the solid waste dissolves in the alcohol solution. Where the solid waste is soil and the PFAS is adsorbed onto clay or other particles in the soil, at least a portion of the PFAS undergoes desorption from the clay then dissolves in the alcohol solution. Thus the solid phase contains any components of the soil which are insoluble in the alcohol solution, such as sand, silt, clay and some organic matter, and the liquid phase contains components of the soil which are soluble in the alcohol solution, such as at least a portion of the PFAS.

Combining the solid waste with an alcohol solution to provide a mixture of a solid phase and a liquid phase may comprise mixing the solid waste with the alcohol solution. This may comprise agitating the mixture for a period of time. Agitating the mixture may comprise, for example, any one or more of stirring, swirling, shaking, mixing or tumbling, The period of time may be between about 0.5 hours and about 5 hours, or between about 0.5-1, 0.5-2, 0.5-3, 0.5-4, 1-2, 1-3, 1-4, 1-5, 2-3, 2-4, 2-5, 3-4, 3-5, or between about 4 and about 5 hours. In some instances the agitating may be for less than 0.5 hours, e.g. from about 10 to about 30 minutes.

The step of combining may comprise a step of soaking. This may comprise allowing the mixture of the solid phase and the liquid phase to rest without agitation. This step may be conducted for a period of at least about 10 minutes, or at least about 20, 30, 40, 50 or 60 minutes, or from about 10 to 60 minutes, or from 10 to 30, 10 to 20, 20 to 60, 30 to 60 or 20 to 40 minutes, e.g. for about 10, 20, 30, 40, 50 or 60 minutes. This step may be conducted before or after agitating the mixture. The method may in some instances comprise two such steps (each independently being as described above), one being conducted before agitating and one conducted after agitating.

Thus in an embodiment, the method comprises:
(i) combining the solid waste with an alcohol solution to provide a mixture of a solid phase and a liquid phase, agitating the mixture for a period of from 0.5 to 5 hours and allowing the mixture to rest without agitation for a period of at least about 10 minutes; wherein the solid phase comprises insoluble components of the solid waste, and the liquid phase comprises the alcohol solution and at least a portion of the PFAS;
(ii) separating the solid phase and the liquid phase to provide cleaned solid waste and an alcohol solution comprising PFAS.

The alcohol solution may comprise an alcohol and water. The alcohol solution may comprise at least about 40% v/v of an alcohol, or at least about 45, 50, 55, 60, 75, 80, 85, 90, or 95% v/v of an alcohol. The alcohol solution may comprise at least about 50% v/v of an alcohol. The alcohol solution may comprise at least about 90% v/v of an alcohol. Examples of suitable alcohols include ethanol, methanol, 1-propanol, 2-propanol, 1-butanol, 2-butanol, and tert-butanol. The alcohol may be ethanol.

The method of the first aspect of the disclosure may be performed at ambient temperature. Ambient temperature may vary depending on the location and season but may typically be between about 0 to 50° C. The method of the first aspect of the disclosure may be performed at ambient pressure. Ambient pressure may vary depending on weather conditions but may typically be about 100 kPa.

In step (i) of the first aspect of the disclosure, the mass ratio of the solid waste containing a PFAS to the alcohol solution may be between about 1:1 and 3:1, or between about 1:1 and 1.5:1, 1:1 and 2:1, 1:1 and 2.5:1, 1.5:1 and 2:1. 1.5:1 and 2.5:1, 1.5:1 and 3:1, 2:1 and 2.5:1. 2:1 and 3:1. or between about 2.5:1 and 3:1. The mass ratio of solid waste containing a PFAS to the alcohol solution may be between about 2:1 and about 2.5:1. The mass ratio of solid waste containing a PFAS to the alcohol solution may be about 1:1, or about 1.5:1, 2:1, 2.5:1, or about 3:1.

In step (ii) of the method of the first aspect of the disclosure the solid phase and the liquid phase are separated. After at least a portion of the PFAS has dissolved in the alcohol solution in step (i), the solid phase comprises cleaned solid waste, and the liquid phase comprises an alcohol solution comprising PFAS. Thus, after separation of the liquid and solid phases, cleaned solid waste and an alcohol solution comprising PFAS are obtained. Cleaned solid waste is solid waste in which the concentration of a PFAS has been reduced, relative to the solid waste containing a PFAS prior to being subjected to the method of the first aspect of the disclosure. In step (ii), separating the solid and liquid phases may be carried out by any suitable means including filtration, centrifugation, flotation, or pressing, or any combination of these, for example using a screw press. Separating the solid and liquid phases may be carried out using a dewatering screw press. If a dewatering screw press is used, step (i) may be carried out in the tank of the dewatering screw press. The dewatering screw press may perform multiple functions in the method. For example, it may be used for any one or more of: combining the solid waste with an alcohol solution to provide a mixture of a solid phase and a liquid phase, agitating the mixture, soaking the mixture and separating the solid phase and the liquid phase. The screw press may have an initial portion having a constant pitch between loops. This initial portion can function as a mixer and a conveyor. A subsequent portion of the screw press may have a varying pitch which can compress the soil so as to at least partially separate the solid phase from the liquid phase.

The method of the first aspect of the disclosure may further comprise a step (iii) of repeating steps (i) and (ii) at least once. That is, the cleaned solid waste obtained in step (ii) may be combined with an alcohol solution to provide a mixture of a solid phase and a liquid phase; wherein the solid phase comprises insoluble components of the solid waste, and the liquid phase comprises the alcohol solution and at least a portion of the PFAS, followed by separating the solid phase and the liquid phase to provide further cleaned solid waste and an alcohol solution comprising PFAS. Steps (i) and (ii) may be repeated multiple times in order to remove further amounts of PFAS from the solid waste containing a PFAS. The liquid phases from each of the times in which steps (i) and (ii) are performed may be combined.

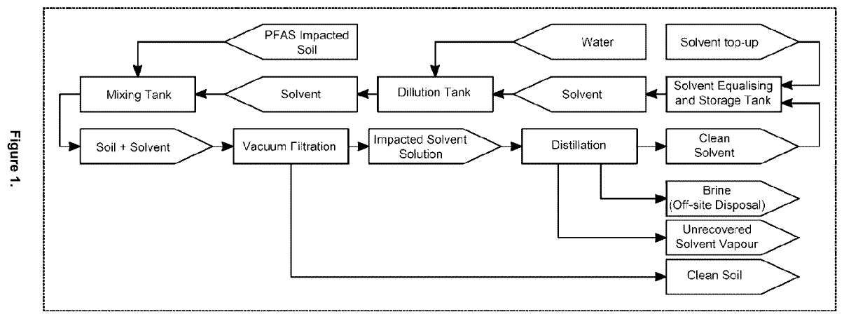

The method of the first aspect of the disclosure may further comprise a step (iv) of distilling the alcohol solution comprising PFAS to provide alcohol substantially free from PFAS and a brine containing the at least a portion of the PFAS. In this case, in step (i) the alcohol solution may comprise the alcohol substantially free from PFAS obtained in step (iv). This enables the alcohol to be recycled. This also reduces the volume of PFAS-containing material requiring further treatment. The brine may be further treated to destroy the PFAS, for example by chemical or thermal treatment. An embodiment of the method of the first aspect of the disclosure involving recycling of the alcohol solution is depicted in FIG. 1.

The method of the first aspect of the disclosure may also comprise a step (i.a.) prior to step (i), comprising measuring the electrical conductivity and/or moisture of the solid waste containing a PFAS and adjusting the electrical conductivity and/or moisture of the solid waste if it does not fall within a target range. The inventors have found that desorption and/or dissolution of PFAS into an alcohol solution may be enhanced when the electrical conductivity and/or moisture of a solid waste containing a PFAS is within a certain range. The target range for the electrical conductivity of the solid waste may be between about 0.01-1000 mS/m, or between about 0.01-1, 0.01-20, 0.01-100, 0.01-500, 1-20, 1-100, 1-500, 1-1000, 20-100, 20-500, 20-1000, 100-500, 100-1000, or between about 500-1000 mS/m. The target range for the moisture of the solid waste may be between about 1-80% v/v, or between about 1-10, 1-20, 1-40, 1-60, 10-20, 10-40, 10-60, 10-80, 20-40, 20-60, 20-80, 40-60, 40-80, or between about 60-80% v/v.

### Apparatus for Removing PFAS

Also described herein is an apparatus suitable for carrying out the method of the first aspect of the disclosure.

In a second aspect of the disclosure, there is provided an apparatus for reducing the concentration of a perfluoroalkyl and polyfluoroalkyl substance (PFAS) in a solid waste containing a PFAS, the apparatus comprising:
(i) a separation unit for separating a mixture of the solid waste and an alcohol solution, the separation unit having a solvent inlet for receiving the alcohol solution or components thereof, a liquid phase outlet for expelling a separated liquid phase, and a solid phase outlet for expelling a separated solid phase; and
(ii) a solvent recovery unit for recovering alcohol substantially free from PFAS from the separated liquid phase, the solvent recovery unit having a liquid inlet for receiving the separated liquid phase, a recovered solvent outlet for expelling recovered solvent and a brine outlet for expelling brine;
wherein the liquid inlet of the solvent recovery unit is in fluid communication with the liquid phase outlet of the separation unit, and the recovered solvent outlet of the solvent recovery unit is in fluid communication with the solvent inlet of the separation unit.

The liquid phase outlet may be fitted with a screen or a filter or similar device to prevent the solid phase from exiting through the liquid phase outlet. It may be located so as to avoid egress of the solid phase from the liquid phase outlet. For example it may be located in a mixing tank above the level at which the solid phase is expected to reach.

The apparatus may further comprise a brine storage tank in fluid communication with the brine outlet of the solvent recovery unit. The apparatus may also comprise a solvent storage tank, having a recovered solvent inlet, which is in fluid communication with the recovered solvent outlet of the solvent recovery unit and a recovered solvent outlet, which is in fluid communication with the solvent inlet of the separation unit. The brine and solvent storage tanks allow for brine and solvent to be accumulated and stored during operation of the apparatus.

The separation unit separates the mixture into a solid phase comprising cleaned solid waste, and a liquid phase comprising the alcohol solution and at least a portion of the PFAS. The separation unit may comprise any suitable means of separating the mixture of the solid waste and an alcohol solution into a solid phase and a liquid phase, e.g. a screen, a filter, a centrifuge etc. The separation unit may also comprise a mixing unit, which serves to mix the solid waste and the alcohol solution to prepare the mixture of the solid waste and an alcohol solution. For example, the separation unit may comprise a filtration apparatus, a flotation apparatus, a centrifuge, or a dewatering screw press. The separation unit may comprise a dewatering screw press. A dewatering screw press may comprise both a mixing unit (such as a tank) and a separation unit (the screw press itself).

The separation unit may comprise an active separation device, for example a centrifuge, a press, a screw auger or a suction device in order to facilitate separation of the liquid phase from the solid phase. It may comprise a passive separation device, for example a suitably located filter or screen. In the latter case, the driving force for separation may be supplied by gravity or it may be supplied by an active separation device as discussed above.

The mixing unit may comprise a stirring blade, a mixing blade, a swirling blade, a shaker, an auger, a tumbling device or some other form of agitation device. Each may be coupled to a motor so as to enable the agitation device to agitate the mixture of solid waste and alcohol solution. It may comprise a dewatering screw press or a mixing portion of a dewatering screw press, e.g. the blades or auger thereof. In some instances more than one agitation device may be used.

Where components of the apparatus are in fluid communication with each other, this may be by way of any suitable conduit, such as a pipe, hose or tubing.

The solvent recovery unit may comprise any suitable means of recovering cleaned solvent from the liquid phase expelled from the separation unit. For example, the solvent recovery unit may comprise a boiler and a condenser. Where the solvent recovery unit is a boiler and a condenser, the apparatus may further comprise a water storage tank, which is in a fluid communication with the distiller. The water storage tank may be provided with water from a water source via a valve.

The apparatus may further comprise one or more pumps. The pumps may be in-line pumps. The one or more pumps may be located, for example, along a conduit joining the separation unit and the solvent recovery unit, along a conduit joining the solvent recovery unit and the brine storage tank, along a conduit joining the solvent storage tank and the separation unit, and/or along a conduit joining the water tank with the solvent recovery unit.

The apparatus may further comprise an electronic controller for controlling and/or automating the operation of the apparatus. The electronic controller may further comprise sensors, such as sensors indicating the level of liquids in the separation unit, solvent recovery unit, brine storage tank, and/or solvent storage tank, and/or sensors indicating the temperature of the solvent recovery unit.

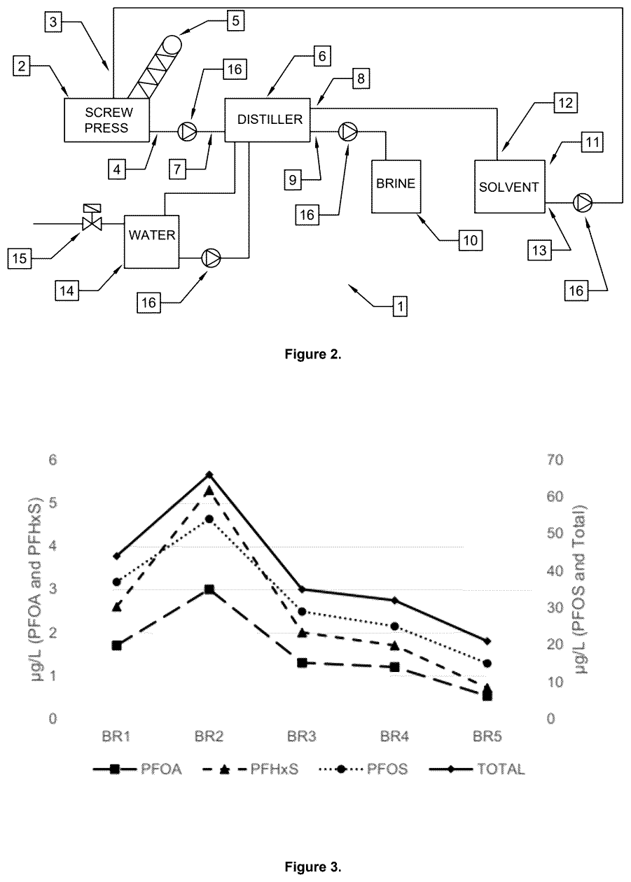

In one embodiment of the invention depicted in FIG. 2, there is provided an apparatus (1) for reducing a concentration of a perfluoroalkyl and polyfluoroalkyl substance (PFAS) in a solid waste containing a PFAS, the apparatus comprising a separation unit (2) in the form of a screw press for separating a mixture of the solid waste and an alcohol solution, the separation unit (2) having a solvent inlet (3) for receiving the alcohol solution or components thereof, a liquid phase outlet (4) for expelling a separated liquid phase, and a solid phase outlet (5) for expelling a separated solid phase; and a solvent recovery unit (6) in the form of a distiller (i.e. a boiler and condenser) for recovering alcohol substantially free from PFAS from the separated liquid phase, the solvent recovery unit having a liquid inlet (7) for receiving the separated liquid phase, a recovered solvent outlet (8) for expelling recovered solvent and a brine outlet (9) for expelling brine; wherein the liquid inlet (7) of the solvent recovery unit (6) is in fluid communication with the liquid phase outlet (4) of the separation unit (2), and the recovered solvent outlet (8) of the solvent recovery unit (6) is in fluid communication with the solvent inlet (3) of the separation unit (2). In this embodiment, the apparatus (1) further comprises a brine storage tank (10) in fluid communication with the brine outlet (9) of the solvent recovery unit (6), and a solvent storage tank (11), having a recovered solvent inlet (12), which is in fluid communication with the recovered solvent outlet (8) of the solvent recovery unit (6) and a clean solvent outlet (13), which is in fluid communication with the solvent inlet (3) of the separation unit (2). The apparatus (1) further comprises a water storage tank (14), which is in a fluid communication with the solvent recovery unit (6). The water storage tank (14) is provided with water from a water source via a valve (15). The apparatus further comprises a number of pumps, in the form of in-line pumps (16). The pumps are located along a conduit joining the separation unit (2) and the solvent recovery unut (6), along a conduit joining the solvent recovery unit (6) and the brine storage tank (10), along a conduit joining the solvent storage tank (11) and the separation unit (2), and/or along a conduit joining the water tank (14) and the solvent recovery unit (6).

In use, solid waste containing a PFAS and an alcohol solution are fed into separation unit (2), which separates the mixture into a solid phase comprising cleaned solid waste, and a liquid phase comprising the alcohol solution and at least a portion of the PFAS. The cleaned solid waste is expelled from the separation unit (2) and may be returned to the site from which it originated, or again fed into the separation unit (2). The liquid phase passes through a conduit to the solvent recovery unit (6), where it is distilled to provide clean, recovered solvent which is substantially free from PFAS. The residue from the distillation is a brine which contains at least a portion of the PFAS. The brine passes through a conduit to the brine storage tank (10), where it is collected for further processing. The clean solvent is passed through a conduit to the solvent storage tank (11). Solvent from the solvent storage tank (11) may be recycled by feeding back in to the separation unit (2).

### EXAMPLES

The present disclosure is further described below by reference to the following non-limiting examples.

### Example 1

### Bench Scale Trials

PFAS impacted soil samples were collected from a contaminated site. Soil samples were analysed for PFAS content.

### Round 1

Impacted soil (70 g) was mixed with ethanol (76% v/v, 104 g) by hand. The mixture was then subjected to vacuum filtration using a 0.45 μm filter. The filtrate was distilled.

Approximately 19% of the mixed mass was lost due to difficulties with filtration, 35% of concentrated solvent (99% ethanol) was recovered by distillation. 17 g of impacted brine was generated. The brine was analysed and found to contain 1.0, 1.2 and 18 μg/L of PFOA, PFHxS and PFOS, respectively. The washed soil could not be sampled.

### Round 2

Impacted soil (78 g) was mixed with ethanol (75% v/v, 104 g) by hand. The mixture was then subjected to gravity filtration. The filtrate was distilled.

79.5% of the diluted solvent was recovered. 79.5% of concentrated solvent (99% ethanol) was recovered by distillation. 30 g of impacted brine was generated. The brine was analysed and found to contain 2.0, 2.6 and 18 μg/L of PFOA, PFHxS and PFOS, respectively. The washed soil was analysed but no reduction in PFAS content was observed.

### Round 3

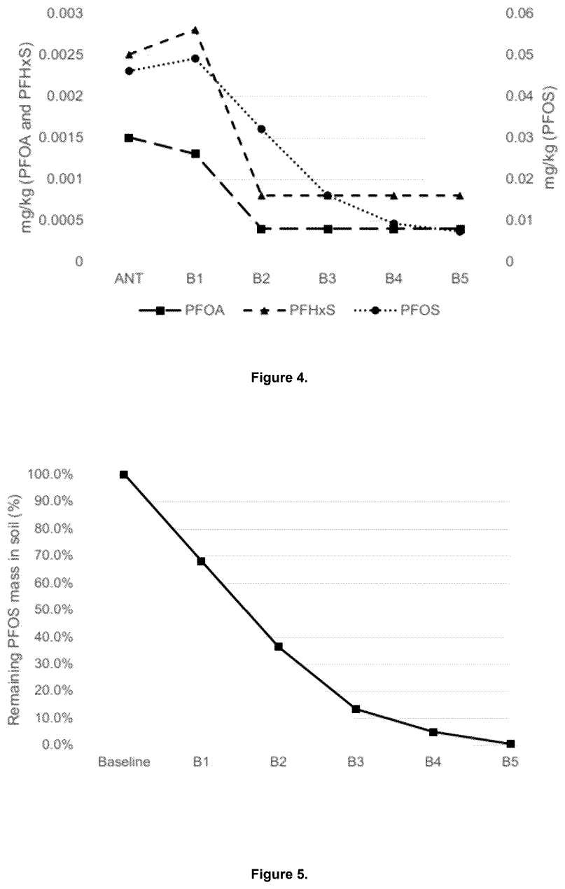

Impacted soil (439 g) was mixed with ethanol (99% v/v, 179 g) in an electric tumbler for 30 min. The mixture was then subjected to gravity filtration. The filtrate was distilled. These steps were repeated using the washed soil a further 4 times, as set out in Table 1a. Mass recovery and losses are set out in Table 1b, and PFOS concentration results are set out in Table 1c. See also FIGS. 3, 4, and 5. In particular, FIG. 4 demonstrates the reduction in concentration of PFOA, PFHxS and PFOS.

TABLE 1a
Process of Round 3.

| | Impacted | Ethanol | Ethanol | Water | Filtered | Distilled |
|---|---|---|---|---|---|---|
| Batch | soil used | added | added | added | ethanol | ethanol |
| Id | (g) | (g) | (% of soil) | (g) | (g) | (g) |
| B1 | 439 | 179 | 41% | 0 | 128 | 61 |
| B2 | 316 | 179 | 57% | 0 | NM | 79 |
| B3 | 267 | 110 | 41% | 50 | 127 | 90 |
| B4 | 202 | 84 | 42% | 0 | 72 | 55 |
| B5 | 140 | 80 | 57% | 0 | 58 | 35 |

TABLE 1b
Mass recovery and losses from Round 3.

| | | Ethanol | | | | |
|---|---|---|---|---|---|---|
| | % | lost during | | Soil | Balance | Other |
| Batch | Ethanol | filtering | Brine | sample | lost | losses |
| Id | recovered | (g) | (g) | (g) | (g) | (g) |
| B1 | 34% | 121 | 43 | 36 | 162 | 41 |
| B2 | 44% | 39 | 17 | 39 | 93 | 54 |
| B3 | 82% | 45 | 37 | 35 | 63 | 18 |
| B4 | 65% | 22 | 17 | 34 | 40 | 18 |
| B5 | 44% | 61 | 23 | 39 | 74 | 13 |

TABLE 1c
PFOS concentration results from Round 3.

| | | Soil | | Total | | Remaining |
|---|---|---|---|---|---|---|
| | | mass | | soil | Total | PFOS |
| | | before | Sample | mass | PFOS | mass in |
| Batch | PFOS | sampling | collected | washed | mass | the soil |
| Id | (mg/kg) | (g) | (g) | (kg) | (mg) | (%) |
| Base- | 0.0460 | 439 | 0 | 0.439 | 2.02 × | 100.0% |
| line | | | | | 10⁻² | |
| B1 | 0.0490 | 316 | 36 | 0.28 | 1.37 × | 67.9% |
| | | | | | 10⁻² | |
| B2 | 0.0320 | 267 | 39 | 0.228 | 7.30 × | 36.1% |
| | | | | | 10⁻³ | |
| B3 | 0.0160 | 202 | 35 | 0.167 | 2.67 × | 13.2% |
| | | | | | 10⁻³ | |
| B4 | 0.0092 | 140 | 34 | 0.106 | 9.75 × | 4.8% |
| | | | | | 10⁻⁴ | |
| B5 | 0.0073 | 49 | 39 | 0.01 | 7.30 × | 0.4% |
| | | | | | 10⁻⁵ | |

Those skilled in the art will appreciate that the disclosure described herein is susceptible to variations and modifications other than those specifically described. It is to be understood that the disclosure includes all such variations and modifications. The disclosure also includes all of the steps, features, compositions and compounds referred to or indicated in this specification, individually or collectively, and any and all combinations of two or more of said steps, features, compositions and compounds.

1.-29. (canceled)

30. A method of reducing a concentration of a perfluoroalkyl and polyfluoroalkyl substance (PFAS) in a solid waste containing a PFAS, the method comprising:
(i) combining the solid waste with an alcohol solution to provide a mixture of a solid phase and a liquid phase; wherein the solid phase comprises insoluble components of the solid waste, and the liquid phase comprises the alcohol solution and at least a portion of the PFAS;
(ii) separating the solid phase and the liquid phase to provide cleaned solid waste and an alcohol solution comprising PFAS;
(iv) distilling the alcohol solution comprising PFAS to provide alcohol substantially free from PFAS and a brine containing the at least a portion of the PFAS
wherein the solid waste is a soil and
wherein the alcohol solution comprises an alcohol and water.

31. The method of claim 30, further comprising:
(iii) repeating steps (i) and (ii) at least once, wherein the solid waste in step (i) is the cleaned solid waste obtained in step (ii).

32. The method of claim 30, wherein in step (i) the alcohol solution comprises the alcohol substantially free from PFAS obtained in step (iv).

33. The method of claim 30, further comprising a step (i.a.) prior to step (i), wherein step (i.a.) comprises measuring the electrical conductivity and/or moisture of the solid waste containing a PFAS and adjusting the electrical conductivity and/or moisture of the solid waste if it does not fall within a target range.

34. The method of claim 30, wherein the method is an ex situ method.

35. The method of claim 30, wherein the method is performed on site.

36. The method of claim 30, wherein the method is performed at ambient temperature.

37. The method of claim 30, wherein the method is performed at ambient pressure.

38. The method of claim 30, wherein the soil contains clay.

39. The method of claim 38, wherein the soil contains at least 15% w/w clay.

40. The method of claim 30, wherein the alcohol solution comprises at least about 40% v/v alcohol.

41. The method of claim 30, wherein the alcohol is selected from the group consisting of ethanol, 1-propanol, 2-propanol, 1-butanol, 2-butanol, and tert-butanol.

42. The method of claim 30, wherein the alcohol is ethanol.

43. The method of claim 30, wherein the PFAS is one or more compounds selected from the group consisting of perfluorobutanoic acid (PFBA), perfluoropentanoic acid (PFPeA), perfluorohexanoic acid (PFHxA), perfluoroheptanoic acid (PFHpA), perfluorooctanoic acid (PFOA), perfluorononanoic acid (PFNA), perfluorodecanoic acid (PFDA), perfluoroundecanoic acid (PFUnA), perfluorododecanoic acid (PFDoA), perfluorotridecanoic acid (PFTrDA), perfluorotetradecanoic acid (PFTeDA), perfluorohexadecanoic acid (PFHxDA), perfluorobutane sulfonate (PFBS), perfluoropentane sulfonate (PFPeS), perfluorohexane sulfonate (PFHxS), perfluoroheptane sulfonate (PFHpS), perfluorooctane sulfonate (PFOS), perfluorononane sulfonate (PFNS), perfluorodecane sulfonate (PFDS), perfluorododecane sulfonate (PFDoS), 1H, 1H,2H,2H-perfluorohexane sulfonate (4:2) (4:2 FTS), 1H, 1H,2H,2H-perfluorooctane sulfonate (6:2) (6:2 FTS), 1H, 1H,2H,2H-perfluorodecane sulfonate (8:2) (8:2 FTS), perfluoroctane sulfonamide (PFOSA), N-methylperfluoroctane sulfonamide (N-MeFOSA), N-ethylperfluoroctane sulfonamide (N-EtFOSA), 2-(N-methylperfluorooctane sulfonamido)-ethanol, 2-(N-ethylperfluorooctane sulfonamido)-ethanol, N-methylperfluorooctanesulfonamidoacetic acid, and N-ethylperfluorooctanesulfonamidoacetic acid.

44. The method of claim 30, wherein the PFAS is one or more compounds selected from the group consisting of perfluorooctanoic acid (PFOA), perfluorooctane sulfonate (PFOS), and perfluorohexanoic acid (PFHxA).

45. The method of claim 30, wherein the mass ratio of the solid waste containing a PFAS to the alcohol solution is between about 1:1 and about 3:1.

46. The method of claim 30, wherein the mass ratio of solid waste containing a PFAS to the alcohol solution is between about 2:1 and about 2.5:1.

47. The method of claim 30, wherein in step (ii) separating the solid phase and the liquid phase is performed using a dewatering screw press.

48. The method of claim 47, wherein step (i) is performed in the tank of the dewatering screw press.

49. The method of claim 30, wherein the concentration of a PFAS in the solid waste containing a PFAS is reduced by at least about 15%.
